(19) United States
(12) Patent Application Publication
(10) Pub. No.: US 2012/0088455 A1
(43) Pub. Date: Apr. 12, 2012

(54) INTER-MODULATION DISTORTION REDUCTION IN MULTI-MODE WIRELESS COMMUNICATION DEVICE

(75) Inventors: Robert T. Love, Barrington, IL (US); Ravi Kuchibhotla, Gurnee, IL (US); Lawrence R. Schumacher, Hoffman Estates, IL (US); Kenneth A. Stewart, Grayslake, IL (US)

(73) Assignee: Motorola Mobility, Inc., Libertyville, IL (US)

(21) Appl. No.: 13/251,800

(22) Filed: Oct. 3, 2011

Related U.S. Application Data
(60) Provisional application No. 61/391,571, filed on Oct. 8, 2010.

(51) Int. Cl. H04B 17/00

(52) U.S. Cl. 455/67.11

(57) ABSTRACT

A method in a multimode wireless communication device that communicates using a first radio access technology in a first mode and using a second radio access technology in a second mode is disclosed. The device determines a state of the first radio access technology, indicates to the second radio access technology a state of the first radio access technology, and adjusts a maximum transmit power limit associated with either the first radio access technology or the second radio access technology based on the state of the first radio access technology.

### CROSS-REFERENCE TO RELATED APPLICATIONS

The present application claims benefits under 35 U.S.C. 119(e) to U.S. Provisional Application No. 61/391,571 filed on 8 Oct. 2010, the disclosure of which is incorporated herein by reference.

### FIELD OF THE DISCLOSURE

The present disclosure relates generally to wireless communications and, more particularly, to the avoidance or reduction of inter-modulation (IM) distortion in multimode wireless communication devices and corresponding methods.

### BACKGROUND

The introduction of new wireless radio access technologies usually occurs in stages due to financial and logistical considerations. For example, it is common for evolved radio access technology infrastructure to be implemented initially in areas with higher population density amidst existing radio access technology infrastructure. Such implementations often require multi-mode user terminals supporting different radio access technologies. The emerging 3GPP LTE radio access technology will be likely be implemented using multimode user equipment (UE) that supports OFDM and CDMA technologies operating simultaneously in neighboring frequency bands. In the United States, for example, simultaneous activation (i.e., uplink transmission) of a CDMA RAT operating at 850 MHz and an OFDM RAT operating at 700 MHz may result in desense of one or the other radio access technologies.

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates Band 13 at 700 MHz with DL and UL LTE Bands.

FIG. 2 illustrates 3^{rd} Order IM Frequency Locations in a 700 MHz LTE receive frequency band.

FIG. 3 illustrates CDMA channels in Block A (A″, A, A′) and B (B, B′) in a 850 MHz Band.

FIGS. 4A-4C illustrate 3rd order inter-modulation (IM) frequency locations in an 850 MHz CDMA Receive frequency band.

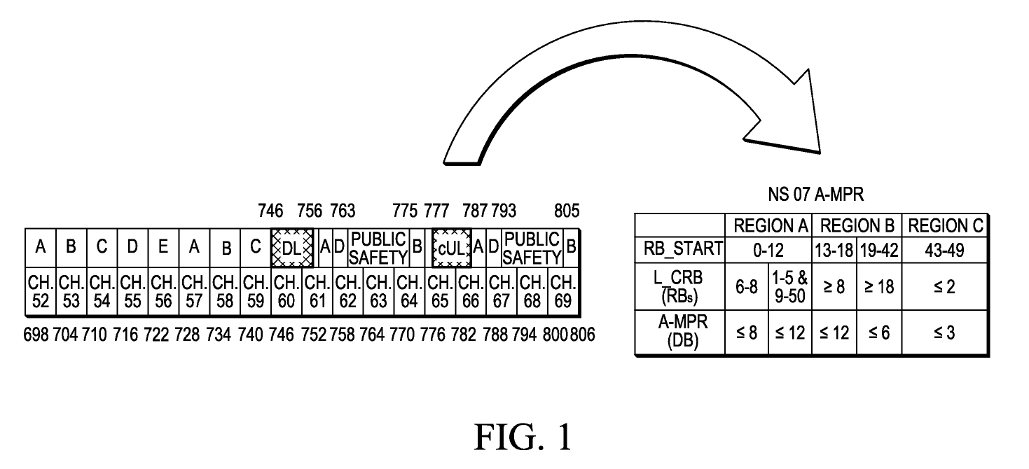

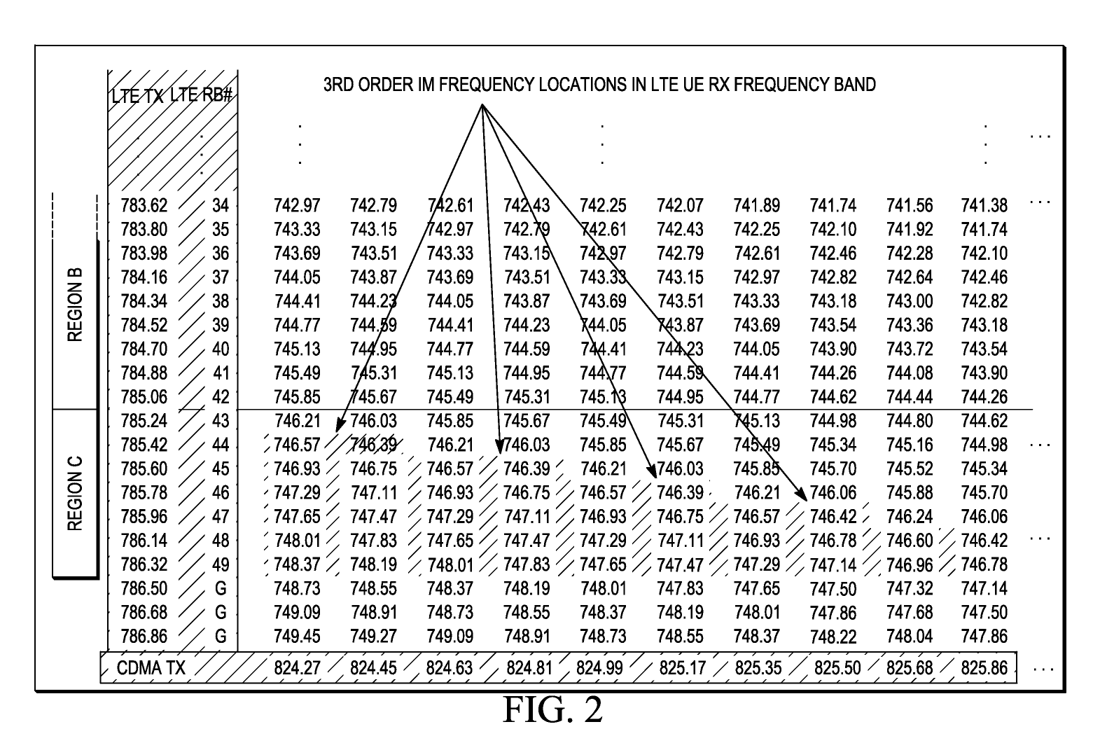

### DETAILED DESCRIPTION

The present disclosure is in the contexts of a wireless communication system comprising infrastructure that supports different radio access technologies where desense is problematic. In one particular implementation, one radio access technology (RAT) is CDMA implemented by 3GPP2 and the other RAT is OFDMA implemented 3GPP LTE protocols. More generally, the radio access technologies may be other technologies that operate in neighboring or overlapping bands. In one implementation, voice data is communicated using one RAT and non-voice calls are communicated using the other RAT.

In one implementation, the present disclosure is concerned with configuring LTE Release 8 CQI feedback so that a dual mode UE (e.g., on that operates LTE at 700 MHz and CDMA at 850 MHz) could signal “fake” CQI reports that indicate to the LTE scheduler when not to schedule certain resource blocks that would desense that UE's CDMA or LTE receiver during simultaneous transmission by UE on the LTE and the CDMA carrier. The technique takes advantage of a UE knowing when it is engaged in a simultaneous CDMA and LTE data call. Another “fake” CQI approach is to simply indicate low CQI for those DL RBs that would be desensed by the UE transmitting on certain UL RBs while transmitting on a CDMA band. Another approach is to define conditional ‘desense’ A-MPR and apply to those UL RBs that would otherwise desense the LTE or CDMA receiver for a given CDMA channel during simultaneous transmissions. “Fake SRS” is also defined where a UE DTXs on SRS regions corresponding to UL RBs that if transmitted on during a CDMA transmission would desense the CDMA receiver. The simplest solution is to just apply conditional ‘desense’ A-MPR. These and other aspects of the disclosure are described more fully below.

In one embodiment, the UE reports a “fake” CQI to avoid receiver desense. According to this embodiment, a PUCCH periodic subband CQI reporting mode 2-1 (selected subband in each of J=3 band parts of 10 MHz band are reported one at a time in a periodic manner) is used along with an aperiodic CQI feedback scheme such as one of the UE-selected subband feedback modes where for 10 MHz the CQI and positions of the “top” M=5 three RB subbands are reported by the dual mode UE whenever it receives an indication via DCI format 0 or a RAR grant.

A dual mode UE in a CDMA voice call would, using LTE CQI reporting mode 2-1, indicate both subband CQI=0 (“out of range”) and the selected subband position (given by an L-bit label) in the band part corresponding to the first 6 of the block of N “desense” RBs that effect the LTE receiver. The subband position containing the first RBs of the block of “desense” RBs is denoted as the “desense” subband position and the band part containing the “desense” subband position is known as the “desense” band part. For mode 2-1, the subband size for 10 MHz is N=6 RBs. The “desense” RBs or “desense” RB block are those RBs over which a UE's transmission would desense its LTE receiver.

A dual mode UE would condition reporting CQI=0, for the “desense” subband position, on its current LTE open loop transmission power level (which is based on reported RSRP) given the onset of or an existing CDMA voice call. Otherwise, given LTE transmission power level is low enough, it would indicate the normal measured subband CQI and position for band part 3. While reporting subband CQI=0 in band part 3 for periodic mode 2-1 the UE would still be triggered (e.g. via DCI format 0) to report (via one of the UE-selected subband aperiodic feedback modes) e.g. its “top” M=5 subband locations and their CQI as normal where chosen subbands may fall in the N RB desense region. Hence, there is no or minimal impact to downlink frequency selective scheduling. Note the occurrence of CQI=0 in band part 3 (mode 2-1) could also be used to trigger further aperiodic CQI reporting. The eNB LTE scheduler would give higher priority to an aperiodic reported subband CQI if the subband RBs overlap with those of a previous periodically reported (mode 2-1) subband with CQI=0. In effect the UE would be reporting two types of CQI, one reflecting LTE signal SINR constituting LTE only signals and interference and another CQI type reflecting SINR that also includes interference from another RAT's inter-modulation products which at least in part depends on LTE maximum transmission power back-off and the other RAT's maximum transmission power back-off where it may only effect a particular frequency range or subband. If the LTE base station (eNB) knows that CQI=0 indicates that a RAT (e.g. CDMA voice call) is on-going or imminent and then takes deliberate scheduling actions (e.g. not scheduling any LTE uplink transmissions for the UE while the other RAT is active or not scheduling certain RBs corresponding to the desense region obtained from e.g. lookup tables at the LTE base station) based on the CQI information then the “fake” CQI signaling is called “explicit”. Note “explicit fake” CQI reporting is then not so “fake” since the LTE base station knows it is “fake” and interprets the CQI information differently than “normal”. On the other hand, if the LTE base station scheduler only attributes the CQI=0 indication as “normal” CQI feedback and schedules accordingly than the “fake” CQI signaling is called “implicit”. In the case of “explicit fake CQI” it may be necessary to have another condition for the LTE base station scheduler to interpret the CQI information differently (i.e. reflecting the CQI information as reflecting interference from multiple RATs). One such condition could be use of a particular subband location in the CQI report or special RSRP or PHR report level (e.g. a particular negative PHR value) by itself or in combination with reporting “CQI=0”. These could in turn be called “fake PHR” or “fake RSRP” reporting and in this case would also be “explicit”.

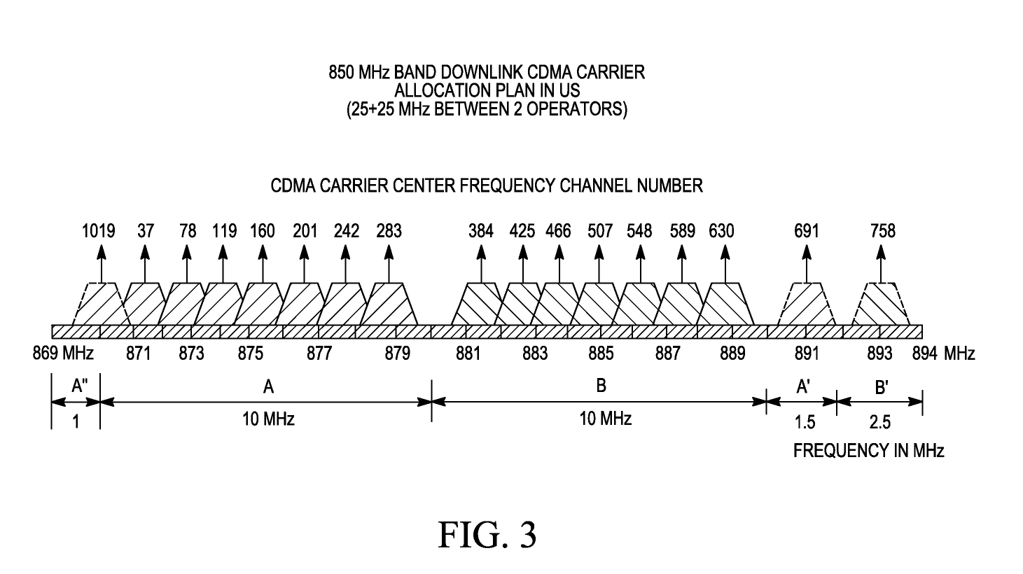

In the above solution a dual mode UE reports CQI=0 for the “desense” subband position conditioned on its current LTE open loop transmission power level (which is based on its power head room reports and RSRP measurements given the onset of or an existing CDMA voice call.) to the LTE receiver desense issue, “fake” CQI indicates to the LTE scheduler when not to schedule the reporting UE to transmit on a certain set of UL RBs (“desense RBs”) that would desense the LTE receiver. The set of “desense RBs” is conditioned on which CDMA channel is active as illustrate in FIG. 3 and Table 1. The “fake” CQI, if “explicit”, can indicate which CDMA channel is active via, e.g., the L-bit label used in PUCCH periodic reporting mode 2-1.

CDMA Channel 1 active: UL RBs 44-49 are not scheduled (else desense occurs for DL RBs 0-5).

CDMA Channel 2 active: UL RBs 47-49 are not scheduled (else desense occurs for DL RBs 0-2).

CDMA Channel>2 active: No LTE scheduler restriction (any UL RBs are used without desense).

TABLE 1
Center, start and ending frequencies of UL and DL CDMA Carriers for Block A

| | A″, A, A′ channel | | | | | | | | |
|---|---|---|---|---|---|---|---|---|---|
| | 1019 | 37 | 78 | 119 | 160 | 201 | 242 | 283 | 691 |
| UL cf | 824.880 | 826.110 | 827.340 | 828.570 | 829.800 | 831.030 | 832.260 | 833.490 | 845.730 |
| DL cf | 869.880 | 871.110 | 872.340 | 873.570 | 874.800 | 876.030 | 877.260 | 878.490 | 890.730 |
| start of ul carrier | 824.26560 | 825.496 | 826.726 | 827.956 | 829.186 | 830.416 | 831.646 | 832.876 | 845.116 |
| end of ul carrier | 825.494 | 826.724 | 827.954 | 829.184 | 830.414 | 831.644 | 832.874 | 834.104 | 846.344 |
| start of dl carrier | 869.266 | 870.496 | 871.726 | 872.956 | 874.186 | 875.416 | 876.646 | 877.876 | 890.116 |
| end of dl carrier | 870.494 | 871.724 | 872.954 | 874.184 | 875.414 | 876.644 | 877.874 | 879.104 | 891.344 |

In an alternative embodiment, the UE directly uses “fake” CQI reporting (also called “implicit fake” CQI reporting) to indicate low CQI values like CQI=0 (alternatively, it can deliberately avoid reporting on the “desense” RBs (or “desense” subband(s)) even though they have the “best” CQI and instead report other lower CQI RBs (or subband(s)) as the “best”) for a certain set of downlink RBs (e.g. 0-5) when a CDMA RAT is active so the LTE scheduler is unlikely to schedule them in which case LTE receiver desense (at RBs 0-5 due to transmitting on RBs 44-49) does not matter. In general depending on which CDMA channel is active the UE reports low CQI (CQI=0) for corresponding DL RBs so that:

CDMA Channel 1 active: DL RBs 0-5 are not scheduled (UL RBs 44-49 can be scheduled);

CDMA Channel 2 active: DL RBs 0-2 are not scheduled (UL RBs 47-49 can be scheduled);

CDMA Channels>2 active: No LTE scheduler restriction on UL or DL RBs.

Alternatively, a UE could apply 10 dB A-MPR to the set of “desense” RBs (the UL RBs that desense the LTE receiver) when the CDMA transmitter was active thus allowing the “desense” RBs to be scheduled. In this case a “fake” CQI is not strictly necessary unless it is important that the LTE scheduler know when the (conditional desense) A-MPR is being applied.

CDMA Channel 1 active: UL RBs 44-49 need 10 dB A-MPR while other RBs need no A-MPR.

CDMA Channel 2 active: UL RBs 47-49 need 10 dB A-MPR while other RBs need no A-MPR.

CDMA Channels>2: No (conditional desense) A-MPR needed for any UL RBs.

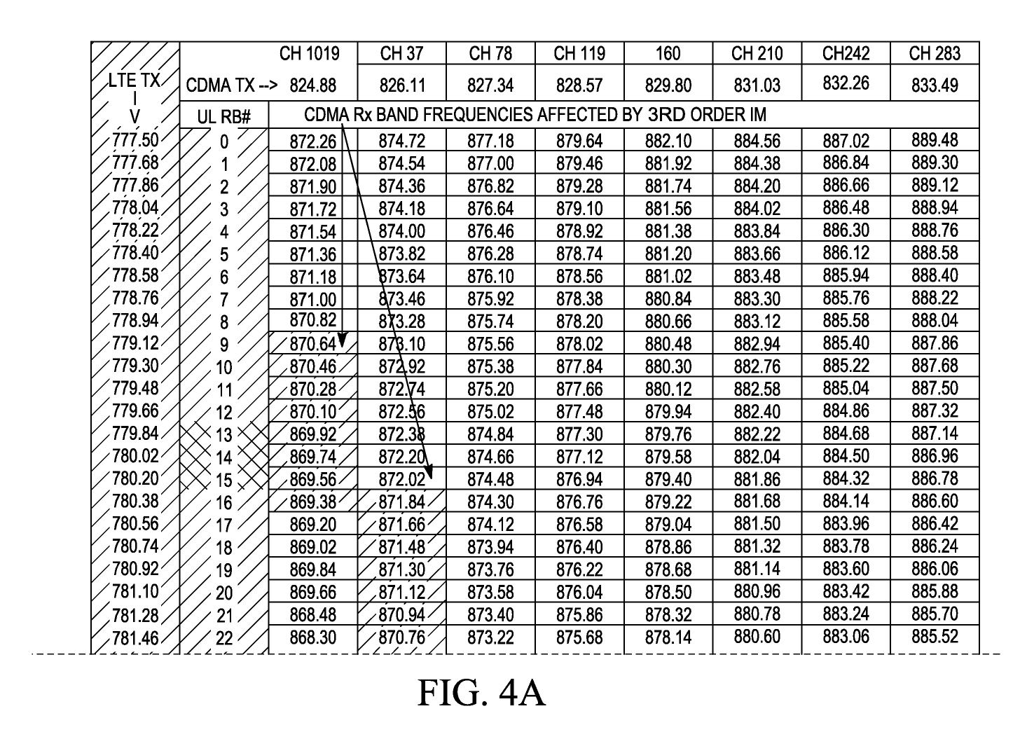

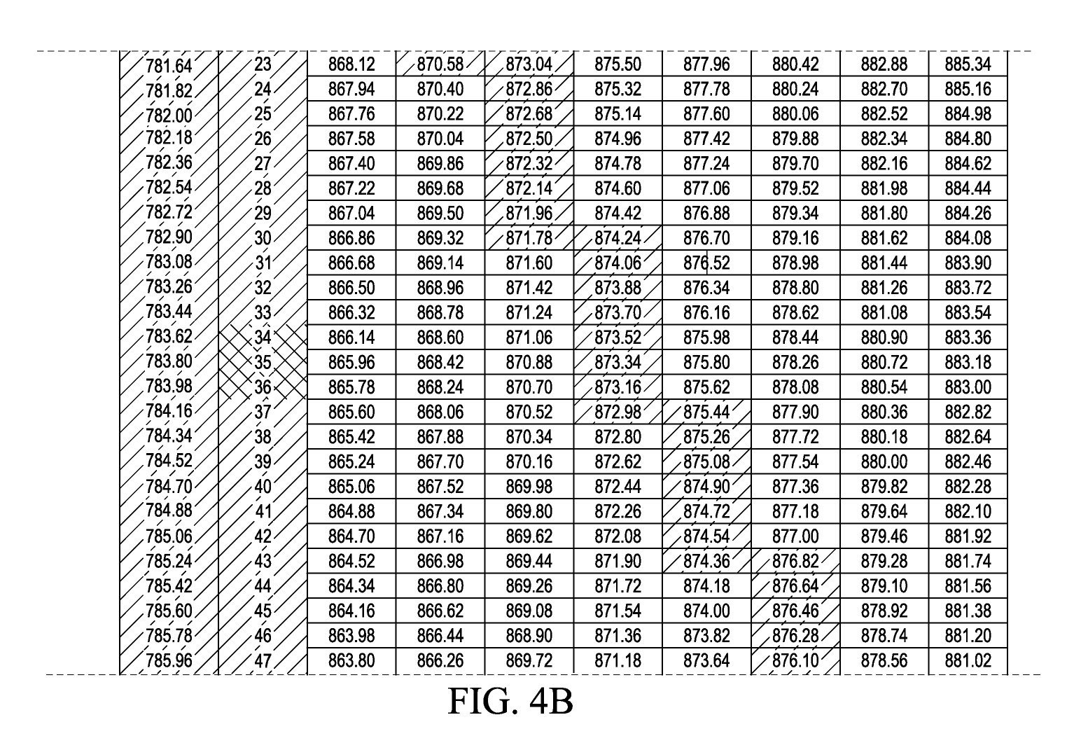

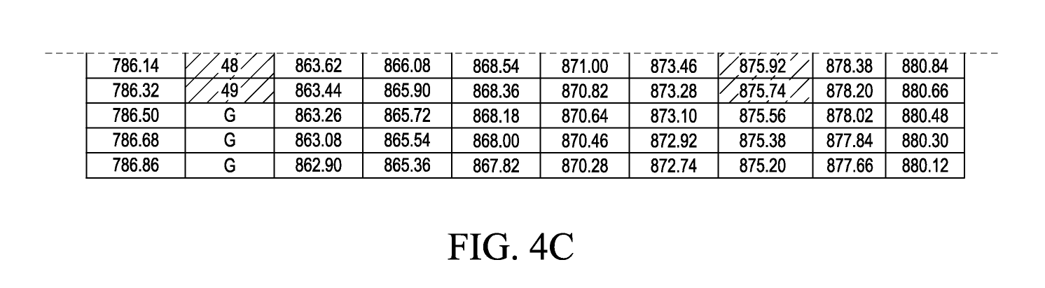

In another embodiment, CDMA receiver desense is avoided. CDMA receiver desense can occur when 3^{rd} order inter-modulation products from simultaneous transmission by the UE in the 700 MHz LTE band and in the 850 MHz CDMA band fall into its CDMA receiver band at 850 MHz. The UL RBs that desense the CDMA receiver depend on the CDMA channel used which is shown in FIGS. 4A-4C. Solution 1 is for UE to simply use conditional ‘desense’ A-MPR as follows:

CDMA Channel 1 active: UL RBs 9-16 need >30 dB A-MPR while other RBs need no A-MPR;

UE only transmits on one set of the hopped PUCCH RBs (RB 34,35,36 as illustrated in FIGS. 4A-4C);

CDMA Channel 2 active: UL RBs 16-22 need >30 dB A-MPR while other RBs need no A-MPR;

CDMA Channel 3 active: UL RBs 22-30 need >30 dB A-MPR while other RBs need no A-MPR;

CDMA Channel 4 active: UL RBs 30-37 need >30 dB A-MPR while other RBs need no A-MPR;

UE only transmits on one set of the hopped PUCCH RBs (RB 13,14,15 as illustrated in FIGS. 4A-4C);

CDMA Channel 5 active: UL RBs 37-43 need >30 dB A-MPR while other RBs need no A-MPR;

CDMA Channel 6 active: UL RBs 43-49 need >30 dB A-MPR while other RBs need no A-MPR;

CDMA Channels>6: No conditional ‘desense’ A-MPR needed for any UL RBs.

(note: CDMA Channel 1-8 correspond to Channels 1019, 37, 78, 119, 160, 201, 242, 283, 691).

Where LTE desense is avoided, a “fake SRS” is used instead of or in addition to conditional ‘desense’ A-MPR to reduce the likelihood of scheduling a set of uplink RBs that would desense the CDMA receiver given simultaneous transmission. That is, a UE will DTX on the SRS regions overlapping the “desense” uplink RBs for the active CDMA carrier so they (“desense RBs) will not be scheduled. This is shown below:

CDMA Channel 1 active: UL RBs 9-16 unlikely scheduled due to DTX on overlapping SRS;

UE only transmits on one set of the hopped PUCCH RBs (RB 34,35,36—see FIG. 4);

CDMA Channel 2 active: UL RBs 16-22 unlikely scheduled due to DTX on overlapping SRS;

CDMA Channel 3 active: UL RBs 22-30 unlikely scheduled due to DTX on overlapping SRS;

CDMA Channel 4 active: UL RBs 30-37 unlikely scheduled due to DTX on overlapping SRS;

UE only transmits on one set of the hopped PUCCH RBs (RB 13,14,15—see FIGS. 4A-4C);

CDMA Channel 5 active: UL RBs 37-43 unlikely scheduled due to DTX on overlapping SRS;

CDMA Channel 6 active: UL RBs 43-49 unlikely scheduled due to DTX on overlapping SRS;

CDMA Channels>6: No DTX on SRS regions needed and all UL RBs used with out desense.

In the solutions for CDMA Channel 1 or 4, the UE only transmits on one of the hopped PUCCH regions (either RB 13,14,15 or RB 34,35,36) to avoid CDMA receiver desense but still allow PUCCH transmission. Since the PUCCH is hopped then DTX on a RB in one of the PUCCH regions can be handled correctly by the eNB receiver (i.e. it looks like severe fading).

The following changes are required to the behaviour of the eNB and multimode UE:

“fake CQI” to indicate active CDMA channel via L-bit label to the eNB to avoid scheduling certain RBs changes eNB behaviour. UE behaviour is of course changed;

“fake CQI” to indicate low CQI for DL RBs when CDMA channel is active so they are not LTE scheduled does not change eNB behaviour. UE behaviour is of course changed;

Conditional ‘desense’ A-MPR applied by UE without eNB knowledge does not change eNB behaviour. UE behaviour is of course changed;

“fake SRS” to indicate poor signal strength for a given SRS region so eNB avoids scheduling certain UL RBs does not change eNB behaviour (although the eNB would need to configure SRS appropriately). UE behaviour is of course changed.

For “fake” CQI concept 1 to work an eNB scheduler will use as a trigger the receiving of a PUCCH periodic mode 2-1 in the band part containing the first RBs of a block of “desense” RBs where the report must contain subband CQI=0 and the subband position corresponding to the first RBs of the LTE receiver block of “desense” RBs. The “desense” RB blocks are known a priori by both the eNB and the UE. Once triggered the eNB scheduler would no longer schedule any of the RBs in the “desense” RB block for as long as the UE continues to report “fake” CQI. Once the UE reports a subband position in the “desense” band part not mapping to the first 6 “desense” RBs or reports the subband position that does include the first 6 “desense” RBs but with CQI>0 then the “desense” scheduler restriction is removed and normal CQI reporting is resumed. To avoid any issues with frequency selective scheduling, it is assumed that an aperiodic reporting mode is also used in conjunction with periodic mode 2-1. Using one of the UE-selected subband aperiodic feedback modes allows the UE to trigger a asynchronous CQI report after receiving a “fake” CQI which can serve to highlight the “true” CQI picture including that of the band part containing the “desense” block of RBs.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a multimode wireless communication device that communicates using a first radio access technology in a first mode and that communicates using a second radio access technology in a second mode, the method comprising:
determining a state of the first radio access technology;
indicating to the second radio access technology a state of the first radio access technology;
adjusting a maximum transmit power limit associated with either the first radio access technology or the second radio access technology based on the state of the first radio access technology.

2. The method of claim 1 wherein indicating to the second radio access technology a state of the first radio access technology includes indicating using a power headroom report (PHR).

3. The method of claim 1 wherein indicating to the second radio access technology a state of the first radio access technology includes indicating using a channel quality indicator report (CQI).

4. The method of claim 1 where indicating the state of the first radio access technology includes aligning a position of a frequency extent of a CQI report in relation to a desense region to indicate additional radio access technology state information.

5. A method in a multimode wireless communication device that communicates using a first radio access technology (RAT) and that communicates using a second radio access technology, the method comprising:
reporting channel quality information (CQI) for radio resources associated with the second RAT to the second RAT while communicating over the first RAT,
the radio resources associated with the second RAT including multiple subbands that comprise multiple resource blocks, wherein each resource block spans multiple subcarriers, the channel quality information includes a CQI associated with at least one subband,
the CQI reported for at least one subband corresponds to a value other than an actual value of the at least one subband, wherein the value reported is chosen to reduce a likelihood that a resource will be scheduled on the at least one subband or adjacent to the at least one subband.

6. The method of claim 5, further including reporting CQI over the second radio access technology when the transmission over the second radio access technology is associated with creating inter-modulation distortion with the transmission over the first radio access technology.

7. The method of claim of 5 wherein the transmission over the second RAT comprises transmission over resource blocks at a transmission power level that cause desense to the first RAT.

8. The method of claim 5, wherein the at least one subband for which the CQI is reported is susceptible to desense when the multimode wireless communication device communicates over the first RAT in the first mode.

9. The method of claim 5, including when communication over the first RAT is completed, restoring normal CQI reporting operation, wherein restoring normal CQI reporting includes CQI reporting using actual values.

10. The method of claim 5, including when communication over the first RAT is completed, reporting CQI for at least one subband using actual values for the at least one subband.

11. The method of claim 5, reporting the CQI for the at least one subband includes reporting a CQI value that is recognized by a scheduling entity as indicating that a resource should not be scheduled on the at least one subband.

12. The method of claim 5 further comprising receiving a scheduling grant after sending the CQI report for the at least one subband, the scheduling grant includes an indicator requesting that the multimode wireless communication device report additional channel quality information.

13. The method of claim 5, reporting the CQI for the at least one subband includes reporting a CQI value that is recognized by a scheduling entity as being a value indicating that a resource should not be scheduled on the at least one subband.

14. A method in a multimode wireless communication device that communicates using a first radio access technology (RAT) and that communicates using a second RAT, the method comprising:
receiving on the first RAT while transmitting on the second RAT;
reducing a maximum power limit for a frequency region associated with the second RAT while transmitting on the second RAT when receiving on the first RAT;
not reducing the maximum power limit for the frequency region associated with the second RAT when the first RAT is not used.

15. The method of claim 14 where not reducing the maximum power limit for the frequency region associated with the second RAT when the first RAT is not used means there is no transmission on the first RAT when there is transmission on the second RAT

16. The method of claim 14 where not reducing the maximum power limit for the frequency region associated with the second RAT when the first RAT is not used means the first RAT is not active.

17. A method in a multimode wireless communication device that communicates using a first radio access technology (RAT) and that communicates using a second RAT, the method comprising:
applying a MPR to the second active RAT conditioned on the first RAT also being active;
determining whether the first RAT is active;
applying an A-MPR to a frequency region in a second RAT band when both first and second RAT are active;
not applying the A-MPR to a frequency region in the second RAT band when only the second RAT is active.

18. A method in a multimode wireless communication device that communicates using a first radio access technology (RAT) and that communicates using a second RAT, the method comprising:
determining whether the first RAT is active;
applying a A-MPR to a frequency region in a second RAT band when both the first RAT and the second RAT are active;
not applying the A-MPR to a frequency region in the second RAT band when only the second RAT is active.
